(19) United States
(12) Patent Application Publication
(10) Pub. No.: US 2007/0199581 A1
(43) Pub. Date: Aug. 30, 2007

(54) CLEANING AND SANITIZING SYSTEM

(75) Inventors: Daniel W. Lynn, Bainbridge Island, WA (US); Jonathan Brandt, Bainbridge Island, WA (US)

Correspondence Address: BLACK LOWE & GRAHAM, PLLC, 701 FIFTH AVENUE, SUITE 4800, SEATTLE, WA, 98104, US

(73) Assignee: Ozone International LLC, Bainbridge Island, WA (US)

(21) Appl. No.: 11/467,872

(22) Filed: Aug. 28, 2006

Related U.S. Application Data
(63) Continuation-in-part of application No. 11/226,990, filed on Sep. 15, 2005, now Pat. No. 7,188,632.
Application No. 11/226,990 is a division of application No. 10/755,527, filed on Jan. 9, 2004, now Pat. No. 7,086,407.

(51) Int. Cl. B08B 3/04

(52) U.S. Cl. 134/26

(57) ABSTRACT

A high pressure water stream (14) is discharged onto a surface to be cleaned. An ozone/water stream (16) is discharged on the same surface for sanitizing the surface. The high pressure water and ozone/water streams (14, 16) are discharged simultaneously along closely adjacent paths that are either parallel (FIG. 3) or concentric (FIG. 2). The water pressure is at least about 100 p.s.i. and is preferably between 100 p.s.i. and 1000 p.s.i. The nozzles that discharge the streams (14, 16) may be movable relative to the object(s) that receives the high pressure water and ozone/water (FIG. 1) Or, they may be fixed and the object my be movable relative to them (FIG. 4)

### PRIORITY CLAIM

This application is a continuation in part of U.S. patent application Ser. No. 11/226,990 filed Sep. 15, 2005, which is a divisional of U.S. patent application Ser. No. 10/755,527 filed Jan. 9, 2004, the contents of which are hereby incorporated by reference.

### FIELD OF THE INVENTION

This invention relates generally to cleaning by use of a high pressure water stream and sanitizing by use of an ozone/water stream and, more specifically, to a cleaning and sanitizing method and apparatus in which the high pressure water stream and the ozone/water stream are discharged together, closely adjacent each other but without mixing.

### BACKGROUND OF THE INVENTION

The following United States patents disclose apparatus and methods of using ozone together with a cleaning fluid: U.S. Pat. No. 5,236,512 granted Aug. 17, 1993, to Ernest E. Rogers, Blaine A. Frandsen and Lamont llislop; U.S. Pat. No. 5,493,754, granted Feb. 27, 1996 to Russell Gurstein and Edgar York; U.S. Pat. No. 5,815,869, granted Oct. 6, 1998 to John M. Hopkins; U.S. Pat. No. 5,839,155, granted Nov. 24, 1998 to Edward D. Berglund, Sung K. Cho and Lowell H. Schiebe; U.S. Pat. No. 6,115,862 granted Sep. 12, 2000 to Theodore R. Cooper, Allyson T. Toney and John B. McParlane; U.S. Pat. No. 6,348,227, granted Feb. 19, 2002, to Luis D. Caracciolo; U.S. Pat. No. 6,455,017, granted Sep. 24, 2002, to John R. Kasting, Dwayne H. Joines and John D. Winings; U.S. Pat. No. 6,458,398, granted Oct. 1, 2002 to Durand M. Smith, Dale S. Winger and Joshuan Brown, and U.S. Pat. No. 6,638,364, granted Oct. 28, 2003 to Gene Harkins and John M. Hopkins.

U.S. Pat. No. 6,454,017 discloses various uses of ozone as a sterilant. In this patent, it is stated that ozone cannot be combined with detergent or other cleaning agents since these are vulnerable to ozone attack. It is also stated that the ozone will destroy both its own effectiveness and that of the cleaning agent rather than attacking pathogens. U.S. Pat. No. 6,455,017 discloses directing a detergent cleaning solution, preferably under pressure, onto a surface to be cleaned. Then following the removal of the soils by the detergent an aqueous ozone rinse is applied to the surface. It is stated that the ozone rinse functions to sanitize the object being cleaned and remove residual detergent. The method of U.S. Pat. No. 6,455,017 involves first directing the cleaning solution onto the surface under pressure, and then rinsing the surface by directing a flow of the ozonated water onto the surface.

U.S. Pat. No. 5,865,995, granted Feb. 2, 1999 to William R. Nelson, and U.S. Pat. No. 6,361,688, granted Mar. 26, 2002, also to William R. Nelson, disclose systems for producing “ozonated water”, also termed “ozone/water.”

There is a need for a system and method that can deliver a high pressure cleaning water stream and an ozone/water stream to both clean and sanitize a surface, without the use of detergents, surfactants, or other chemicals.

### SUMMARY OF THE INVENTION

In one example, the cleaning and sanitizing system includes a first discharge nozzle from which a stream of high pressure water is discharged and a second discharge nozzle from which a stream of ozone/water is discharged. The first and second nozzles are positioned adjacent to each other so that the water and ozone/water streams are contiguous but the ozone/water is not delivered in the high pressure water stream. The high pressure water stream is discharged at a pressure high enough that it will exert a cleaning force on a surface to be cleaned and would convert the ozone into oxygen if the ozone/water stream were to be delivered into the high pressure water stream. In preferred form, the pressure of the high water pressure stream is at least about 100 p.s.i. More preferably, the pressure of the high pressure water stream is between 100 p.s.i. and about 1000 p.s.i. The pressure of the ozone/water stream is smaller than the pressure of the high pressure water stream and is sufficiently small that the ozone is not converted into oxygen.

In some examples of the invention, the ozone/water stream concentrically surrounds the high pressure water stream.

In other examples of the invention, the high pressure water and the ozone/water are discharged as closely spaced substantially parallel stream.

The nozzles for discharging the high pressure water and the ozone/water can be movable to the object that is to be cleaned. Or, the discharge nozzles can be fixed and the article to be cleaned can be moved relative to the nozzles.

In an embodiment of the cleaning and sanitizing system of the present invention, a circulating flow path of ozone/water is provided. Along this path, one or more high pressure water discharge nozzles are provided. An ozone/water nozzle is associated with each high pressure water nozzle. The high pressure water stream may be used to “pump” or “aspirate” ozone/water from the circulating system. As ozone/water is removed from the system, new water is delivered to the ozone/water generator and additional ozone is added to the water in the generator.

In yet other examples of the invention, an object to be cleaned and sanitized is treated with high pressure water in order to remove bulky soil or other such items desired to be removed. An ozone/water rinse is then applied to act as a cleaning or degreasing agent, then treated with high pressure water in order to remove grease, oils, and other objects that have become more readily removable by the ozone/water rinse. Finally, an additional ozone/water rinse is applied in order to sanitize the surface.

Other objects, advantages, and features of the invention will become apparent. From the description of the best mode set forth below, from the drawings, from the claims and from the principles that are embodied in the specific structure that are illustrated and described.

### BRIEF DESCRIPTION OF THE DRAWINGS

Preferred and alternative embodiments of the present invention are described in detail below with reference to the following drawings.

FIG. 1 is a fragmentary side elevational view showing a workman in the process of cleaning and sanitizing an object, by use of a high pressure water stream and an ozone/water stream;

FIG. 2 is a side elevational view of the wand shown in FIG. 1, showing a portion of the wand in longitudinal section, such view showing a first nozzle discharging high pressure water stream surrounded by a second nozzle discharging an ozone/water stream;

FIG. 3 is a somewhat schematic view of a second embodiment of the wand, showing the high pressure water nozzle and stream and the ozone/water nozzle and stream in a side-by-side relationship;

FIG. 4 is a view of an apparatus for conveying chickens or other fowl along a path that is between stationary nozzles for delivering a high pressure water stream, for cleaning the fowl, and an ozone/water stream, for sanitizing the fowl; and

FIG. 5 is a flow diagram of a system embodying the present invention.

FIG. 6 is a side view of a system for cleaning poultry tubs in accordance with an embodiment of the present invention

FIG. 7 is a perspective view of a system for cleaning hides in accordance with an embodiment of the present invention;

FIG. 8 is a side view of an alternative embodiment of a system for cleaning hides in accordance with an embodiment of the present invention; and

FIG. 9 is a process flow diagram of a method for cleaning in accordance with an embodiment of the present invention.

### DETAILED DESCRIPTION OF THE INVENTION

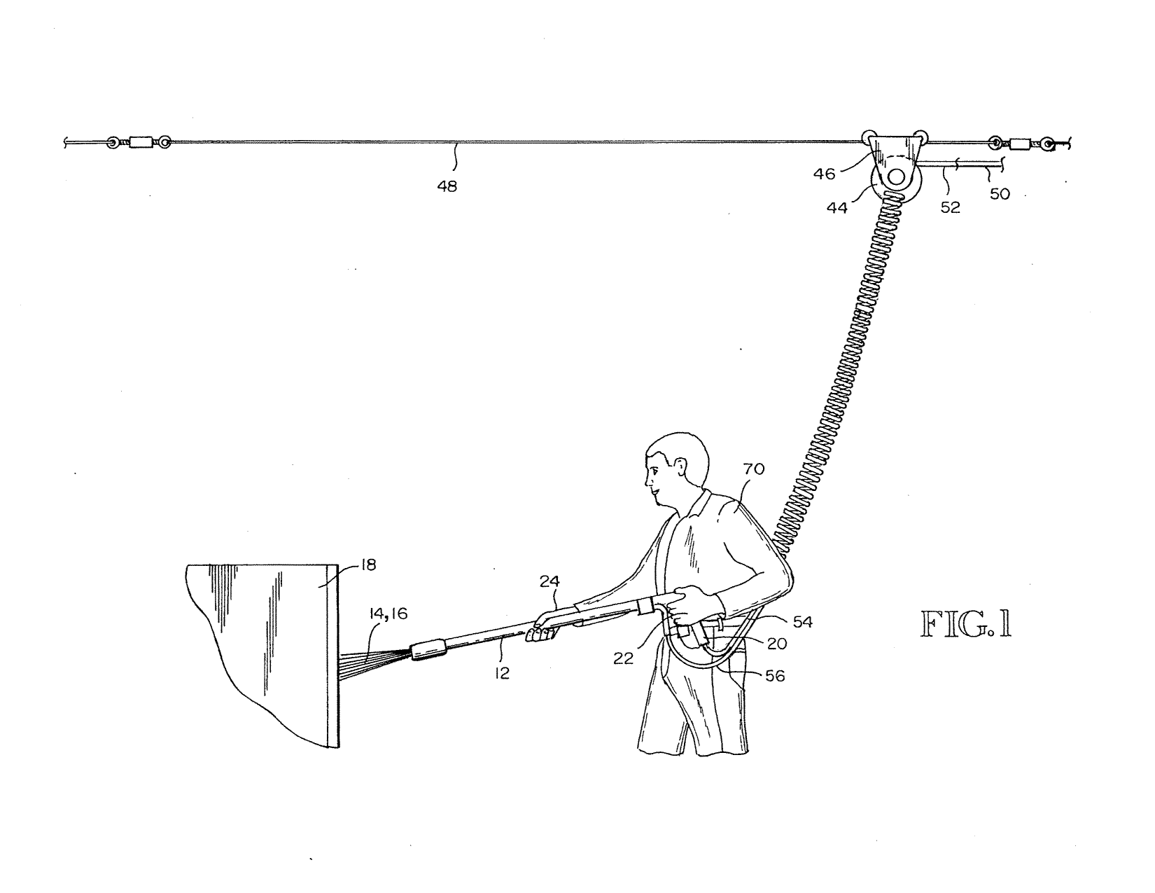

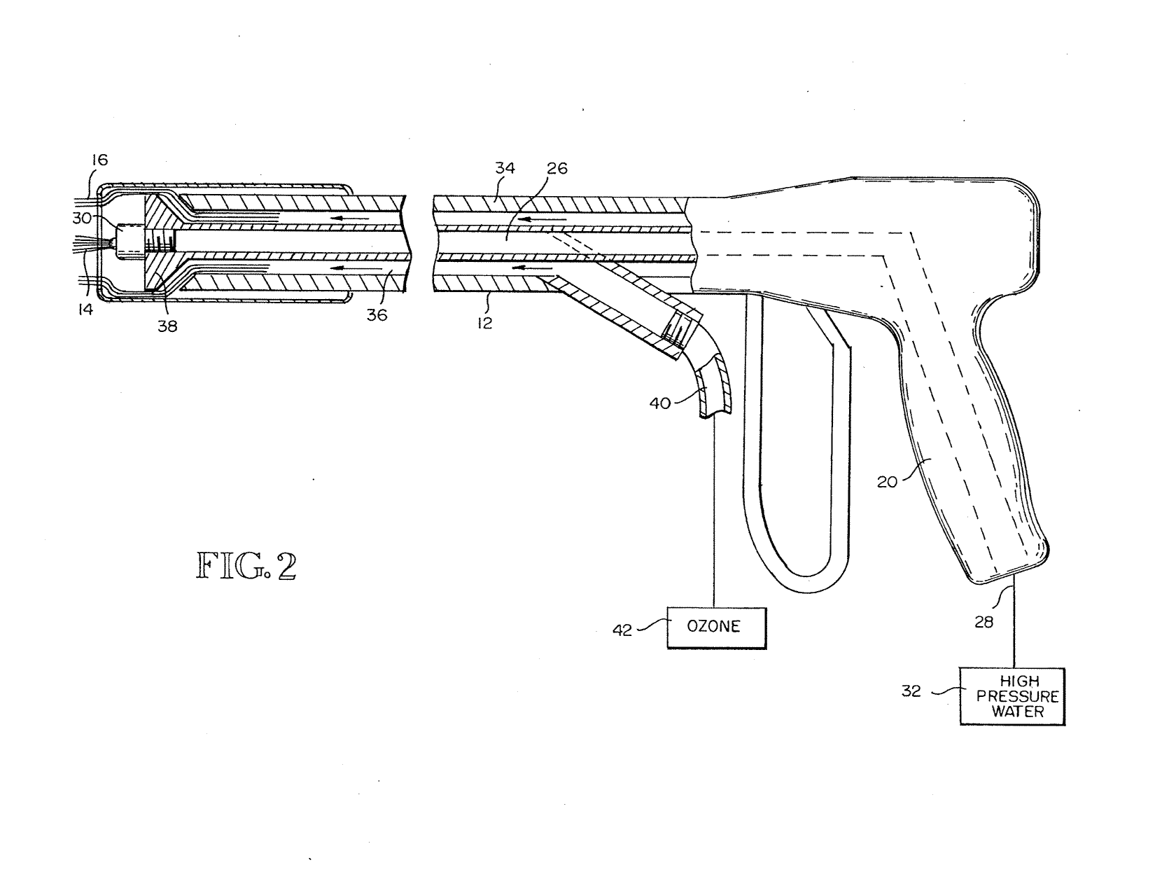

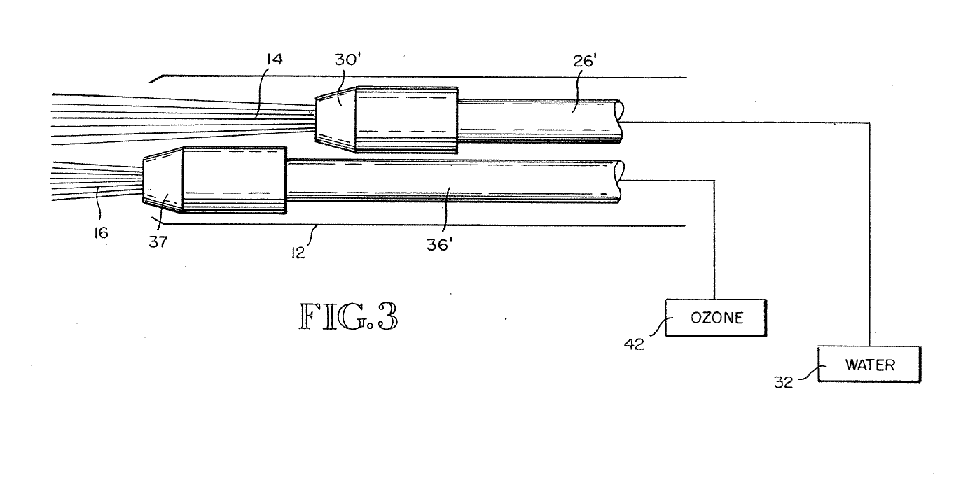

FIG. 1 shows a workman 10 holding a wand 12 that is adapted to discharge a high pressure water stream, for cleaning, and an ozone/water stream for sanitizing. The two streams 14, 16 are being discharge against an object 18 that needs to be cleaned and sanitized. FIG. 2 shows the high pressure water stream 14 surrounded by the ozone/water stream 16. FIG. 3 shows the high pressure water stream 14 and the ozone/water stream 16 being discharged in a side by side relationship.

Referring to FIG. 2, the wand 12 has a grip portion 20 that the workman 10 grips with one hand 22. The workman's other hand 24 grips an elongated central portion of the wand 12. In this embodiment, the wand 12 includes a conduit 26 that extends through the wand 12 from an inlet 28 to an outlet 30. The inlet 28 is connected to a source of high pressure water 32. The outlet 30 is in the form of a discharge nozzle that discharges a stream of the high pressure water 14. Wand 12 includes a tubular outer wall 34 that surrounds the high pressure water conduit 26. An annular passageway 35 is defined by and radially between the two tubular walls 26, 34. A cone 38 is provided at the outlet of the annular passageway 36. A conduit 40 delivers ozone from a source 42 into the passageway 36. The ozone/water flows through passageway 36, and through diagonal ports in cone 38 and discharges as an annular stream 16 surrounding stream 14, Streams 16, 14 do not directly impinge. They extend substantially parallel to each other along a relative small diameter combined stream path.

The conduits 28, 40 include suitable on-off valves that are not shown, but can be like the many valves that are available for controlling fluids that flow through conduits.

FIG. 3 shows a wand 12 that includes a high pressure water conduit 26′ positioned closely adjacent an ozone/water conduit 36′. As previously described, the high pressure water stream 14 and the ozone/water stream 16 are discharged in close proximity to each other but neither infringes directly on the other. There is no attempt to mix the ozone/water stream 16 with the high pressure water stream 14. The high pressure water conduit 26′ will include an off/on valve and the ozone/water stream 36′ will also include an off/on valve. The valves may also control the pressure and discharge flow rate of the two streams 14, 16, in a known matter.

Although the high pressure water and the ozone/water are illustrated as emerging simultaneously from the wand, the invention may also be practiced by having ozone/water and high pressure water alternately emerge from the wand. In one example, an electrical or mechanical valve controller automatically alternates to open and close the flow of ozone/water and high pressure water. Most preferably, the two streams will alternate in relatively rapid succession.

FIG. 1 shows an overhead hose reel 44 on a pulley 46. Pulley 46 is adapted to travel along a rod or a line 48. The reel 44 is preferably a dual reel. It supports a high pressure water hose 50 and an ozone/water hose 52. As the worker 10 walks forwardly from the position shown in FIG. 1, the pulley 46 will move forwardly on the rod or line 48. In a manner that is known to those skilled in the art, a first coiled hose 54 and a second coil holds 56 extended downwardly from the reel 44. The coils 54, 56 are in the nature of coil springs. They will extend when the operator 10 and the wand 12 move forwardly. They will retract when the operator 10 and the wand 14 move rearwardly.

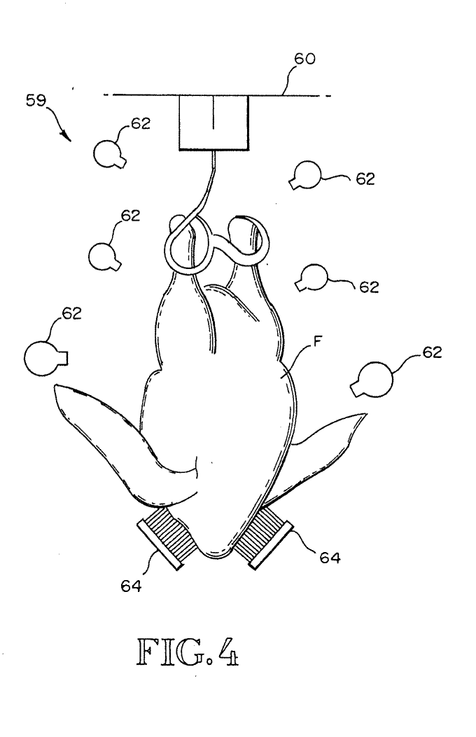

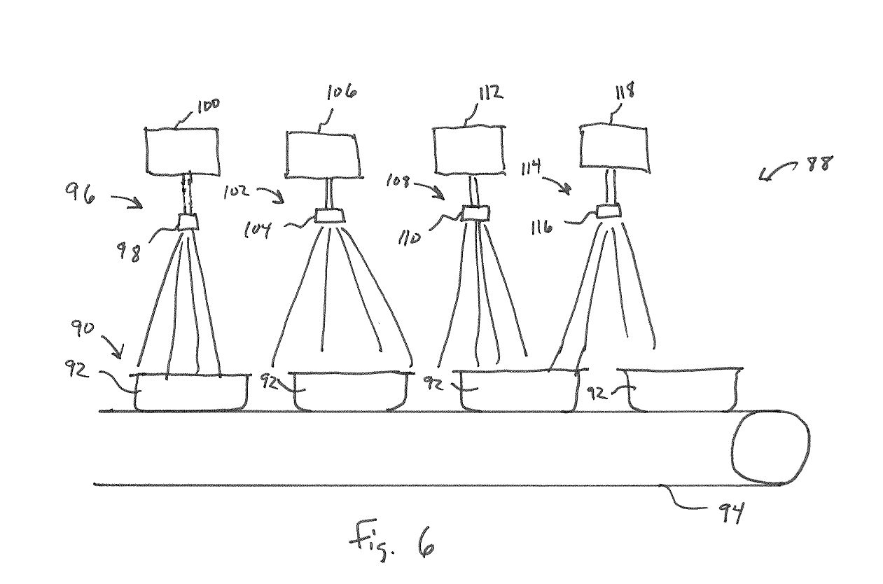

FIG. 4 is substantially like FIG. 6 in the aforementioned U.S. Pat. No. 6,348,227 B1. A conveyor 60 is shown conveying a fowl 62 (e.g. chicken or turkey) or some other animal or object a path, through a processing area between high pressure water and ozone/water streams discharging from nozzles 62. In addition to the nozzles 62, the system 59 may include brushes 64, as described in U.S. Pat. No. 6,348,227 B1. The nozzles 62 are constructed to discharge a stream of high pressure wash water 14 closely adjacent a stream of ozone/water, but without direct mixing of the two streams.

As has been described, the high pressure water stream 14 and the ozone/water stream 16 may be brought to the object or article to be cleaned and sanitized. Or, the high pressure water stream 14 and the ozone/water stream 16 may be discharged from stationary nozzles (e.g. nozzles 62) towards a moving object or objects (e.g. fowl that are moved relative to the stationary nozzles 62).

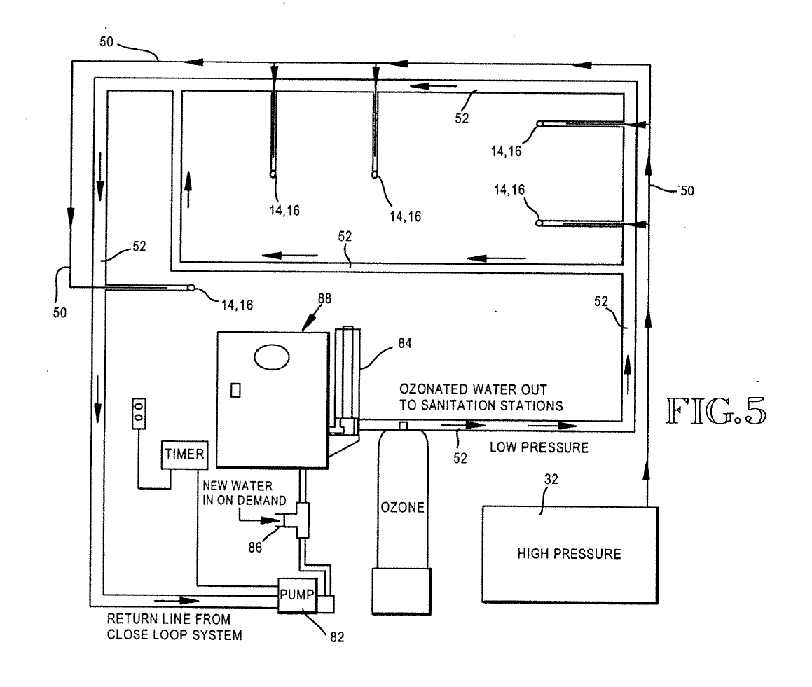

FIG. 5 shows a cleaning and sanitizing system that utilizes the present invention. High pressure water is pumped from source 32 into conduit 50 and from conduit 50 to the nozzle 30, 30′ that forms the high pressure water stream 14. Ozonated water (ozone/water) 10 is delivered from apparatus 80 into conduit 52 which leads to the nozzles from the ozone streams 16. The apparatus 80 for admixing ozone to water may be one of the apparatuses disclosed in the aforementioned U.S. Pat. No. 5,865,995 and U.S. Pat. No. 6,361,688. The contents of these patents are hereby incorporated herein by this specific reference.

The ozonated water conduit 52 forms a closed loop with the apparatus 80. A pump 82 pumps the ozone/water in conduit 52 to the recirculated liquid inlet of a contact tank 84. See inlet 112 in U.S. Pat. No. 6,361,688 leading into contact tank 36 disclosed in that patent. The high pressure water stream 14 will pump or aspirate the ozone/water and remove it from the closed loop conduit 52. Because some of the ozonated water is discharged from the water nozzles 30, 30′, new water is added at 86 into admixture with the recirculated ozone/water that is moved by pump 82 into the inlet of the contact chamber 84.

Preferably, the cleaning water that is discharged from the nozzles 30, 30′ is water only. That is, it does not include a detergent or some other chemical. The surface to be cleaned is cleaned by the force of the high pressure water stream rather than by a detergent or other additive to the water stream. The ozone/water stream is delivered directly on the surface that is being cleaned by the water stream and there is no chemical present with which the ozone may react.

Referring to FIG. 6, in an alternative embodiment, a system 88 includes a plurality of articles 90 bearing animal fats or like contaminants. For example, tubs 92 used to convey slaughtered poultry may be cleaned using the system 88. The articles 90 are conveyed by means of a conveyor belt 94, or other conveying system. The articles 90 may rest on the conveyor belt or be suspended therefrom by means of hooks.

The articles 90 are conveyed through a first spraying station 96 where one or more nozzles 98 coupled to a high pressure water source 100 direct one or more streams of high pressure water at the articles 90. The first spraying station 96 serves to remove soiling that can be readily removed by high pressure in order to expose soiling removable in subsequent spraying stations. In general, this spraying station will remove larger items and perhaps a portion of surface grease. The jets of water preferably have a pressure between 100 and 2000 p.s.i. In the preferred embodiment, the water from the high pressure water source 100 includes no solvents, detergents, or other cleaning chemicals used to cause saponification of fats. In the most preferred embodiment, the water used contains nothing other trace amounts of minerals and impurities typically found in water delivered by a public utility. The water also preferably includes only cold water at or below room temperature. In one embodiment, water having a temperature of from 10 to 25 degrees Celsius is used.

After spraying at the first spraying station 96, the articles 90 are conveyed to a second spraying station 102. The second spraying station 102 directs one or more jets of water at the articles 90 from one or more nozzles 104 coupled to an ozonated water source 106. The ozonated water sprayed from the nozzles 104 is typically at a temperature and pressure such that the dissipation and decay of the ozone into oxygen is reduced. The pressure of the ozonated water is therefore much less than the pressure of the pressure at the first spraying station 96.

The ozonated water is effective to break up animal fats without saponification. In prior sanitation systems a chemical surfactant or degreaser is used to break down lipids such as fat, grease and oil. The chemical reaction known as saponification is typically responsible for breaking down the lipids. Saponification is defined as the action of changing insoluble animal fats and oils into a soluble soap. This is achieved through the chemical reaction between a surfactant and the insoluble animal fat. The surfactant changes the chemical structure of the fat and turns it into a glycerol, which has the molecular structure found in most soap. Glycerol is soluble in water and therefore is removable only with extensive processing. Glycerol is also prone to reaction with minerals within water to form insoluble compounds (e.g. soap scum) which is difficult to remove.

Ozone entrained in the ozonated water from the second spraying station 102 achieves removal of grease in a chemical reaction referred to as “cell lysis.” Cell lysis is the destruction of the cellular wall of the insoluble fat cells or molecules by the ozone, allowing for the fat to be physically removed through the use of high-pressure water or other force.

Once the bond between the surface and the cell wall is broken, the insoluble fat is readily removed from articles 90 at a third spraying station 108 by means of one or more jets of water emitted by one or more nozzles 110 coupled to a high pressure water source 112. The high pressure water source 112 may be the same as the high pressure water source 100 or be a distinct source of high pressure water. The high pressure water preferably includes no solvents, detergents, or other cleaning chemicals used to cause saponification of fats. In the most preferred embodiment, the high pressure water preferably contains nothing other than trace amounts of minerals and impurities typically found in water delivered by a public utility. The high pressure water also preferably includes only cold water at or below room temperature. In one embodiment, water having a temperature of from 10 to 25 degrees Celsius is used. The high pressure water preferably has a pressure between 100 and 2000 p.s.i.

The articles 90 may be conveyed to a fourth spraying station 114 where one or more jets of ozonated water are directed at the articles 90 from one or more nozzles 116 coupled to an ozonated water source 118. The ozonated water source 118 may be the same as the ozonated water source 106 or be a distinct source of ozonated water. The ozonated water may serve to disinfect the articles 90 following the soil removal and degreasing of the prior steps. The ozonated water sprayed from the nozzles 116 is typically at a temperature and pressure such that the dissipation and decay of the ozone into oxygen is reduced. The pressure of the ozonated water is therefore much less than the pressure of the pressure at the first and third spraying stations 96, 108

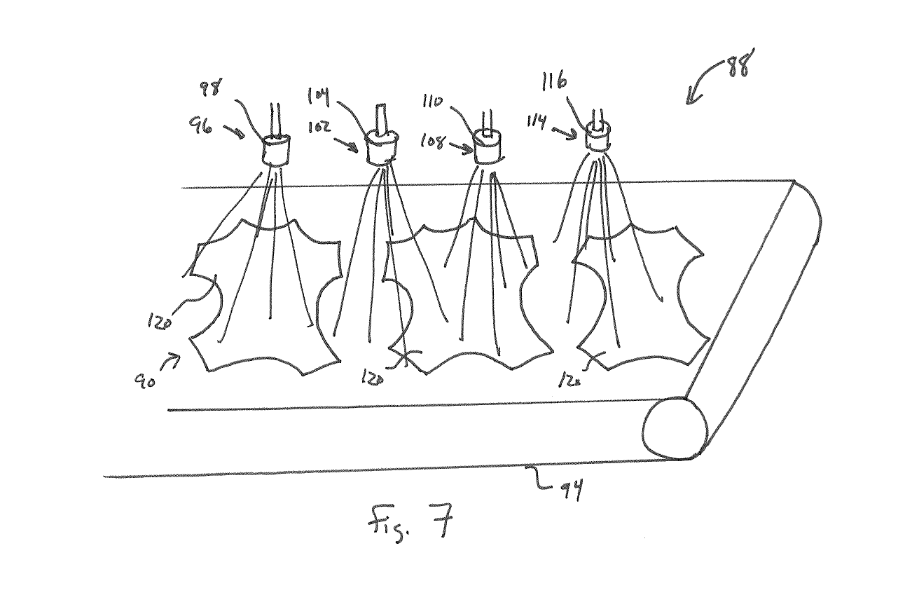

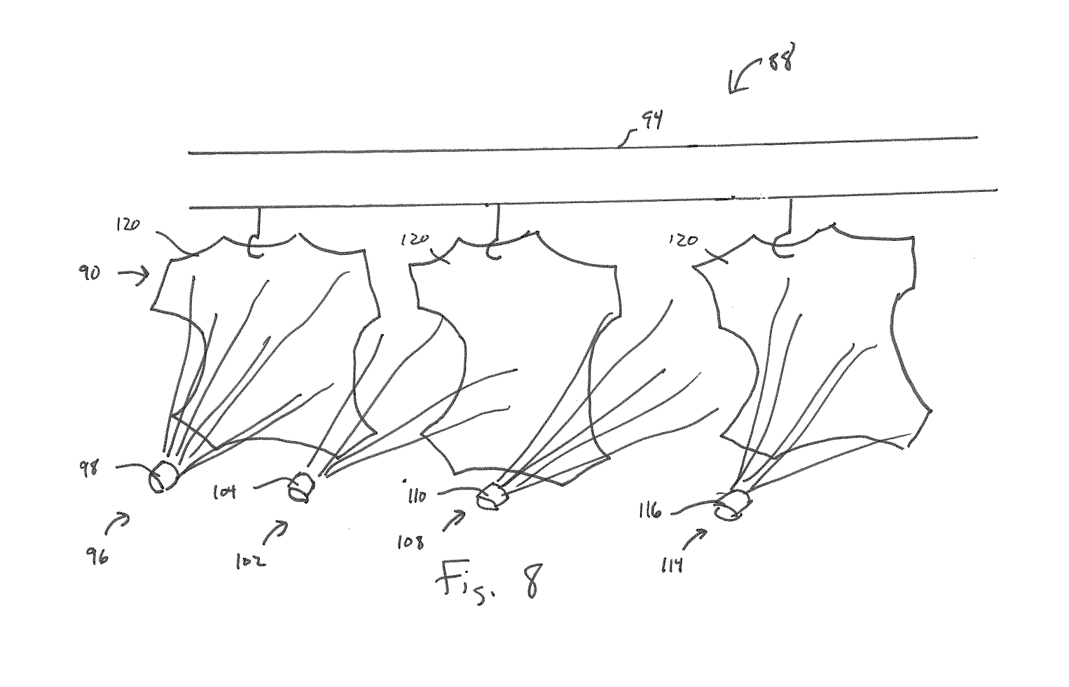

Referring to FIGS. 7 and 8, the system 88 described above may be used to clean articles 90 such as animal hides 120 in order to remove fat and other tissue. The hides 120 may be lain on a conveyor 94 or may be suspended by hooks 122 from the conveyor 94 as they move through the spraying stations 96, 102, 108, 114, fat and other tissues are removed through the process of cell lysis and rinsing as described above. In prior systems, hides are cleaned using high pressure hot water mixed with a caustic chemical to remove soil. The caustic chemical is then rinsed away using a hot water rinse. The hides are then rinsed with ozonated water or a chemical sanitizer followed by a fresh water rinse. The prior method requires large amounts of energy to heat the water and produces wastewater that includes caustic chemicals, sanitizing chemicals, and saponified animal tissue.

Using the novel process disclosed, there are no cleaning chemicals in the wastewater inasmuch as ozone simply dissipates and decays into oxygen over time. Tissue and fats removed by the ozone remain in an insoluble form and are easily removed by filtering or skimming the wastewater. Furthermore, rinsing is accomplished by means of cold water, which greatly reduces the energy requirements of the system 88.

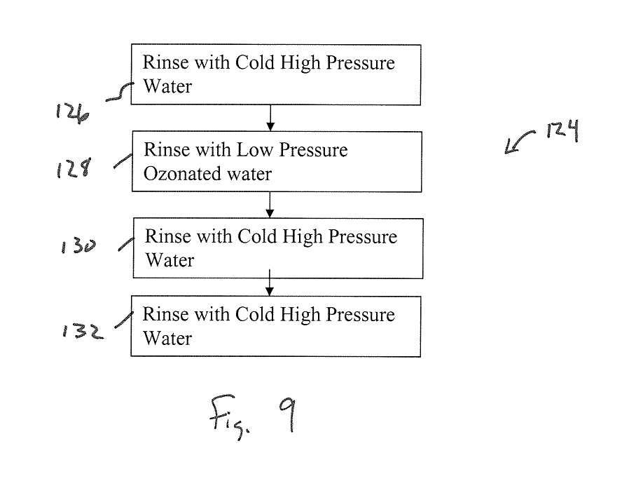

A method 124 for cleaning articles 90, such as animal processing tubs or hides, is illustrated in FIG. 9. At block 126, the article is rinsed using high pressure water, preferably at a pressure between 100 and 2000 p.s.i. The water used at block 126 preferably contains no solvents, detergents, or other chemicals causing saponification. In a preferred embodiment, the water is cold, such that no heating of the water is required. The temperature at which water is delivered by a public utility is typically suitable. In a preferred embodiment, the water is at a temperature from 10 to 25 degrees Celsius. At block 128, the article is rinsed using low pressure ozonated water. At block 130, the article is rinsed using high pressure water, which may be cold and preferably includes no solvents, detergents, or other chemicals causing saponification. At block 132 the article is rinsed using low pressure ozonated water. The steps of blocks 126-132 may be performed at distinct spraying stations 96, 102, 108, 114 or one or more steps may be performed at the same location by the same or different nozzles.

Articles 90 cleaned according to the novel methods and systems disclosed herein do not require the application of any other detergent, sanitizer, saponifiying substance, or other chemical prior to use in applications where the presence of bacteria or grease are undesirable. For example, the tubs 92 of FIG. 6 may be reused to hold poultry without any further steps, other than of drying or rinsing with ozonated or non-ozonated water in some instances. The steps of the method 124 may be repeated to achieve further cleaning. For example, alternating high pressure and ozonated water rinses may be performed until a desired degree of cleanliness is achieved where the soil load is especially great or has become caked or dried onto an article 90.

The embodiments of the invention as illustrated in FIGS. 5-9 depict an automated form in which the sprayers are trained over a moving conveyor. In alternate forms of this example of the invention, the cleaning process may be performed manually, or in a less automated form. For example, the process may be performed using a spraying wand that is hand-held and sprays ozone/water, high pressure water, or both. Likewise, it may be performed without the use of a conveyor.

The illustrated embodiments are only examples of the present invention, and therefore, are non-limitive. It is to be understood that many changes in the particular structure, materials, and features of the invention may be made without departing from the spirit and scope of the invention. Therefore, it is my intention that my patent rights not be limited by the particular embodiments that are illustrated and described herein, but rather are to be determined by the following claims, interpreted according to accepted doctrine of claim interpretation, including the use of the doctrine of equivalence.

I claim:

1. A method for cleaning a soiled article, comprising:
directing a first ozonated water stream at the article, the first ozonated water stream containing no detergents;
directing a first high pressure water stream at the article, the first high pressure water stream containing no detergents; and
directing a second ozonated water stream of at the article, the second ozonated water stream containing no detergents.

2. The method of claim 1, further comprising directing an initial high pressure water stream at the article prior to directing the first ozonated water stream at the article.

3. The method of claim 1, wherein the initial high pressure water stream contains no detergent.

4. The method of claim 1, further comprising moving the article to be cleaned on a conveyor that travels into the path of the first ozonated water stream.

5. The method of claim 4, wherein the soiled article includes animal fats.

6. The method of claim 5, wherein the article is a tub soiled with poultry fats.

7. The method of claim 6, further comprising reusing the tub to hold poultry subsequent to directing the second low pressure ozonated water stream at the tub with no intervening application of a saponifying substance, detergent, sanitizer, or cleaning chemical.

8. The method of claim 5, wherein the article is an animal hide.

9. The method of claim 4, wherein the first high pressure water stream has a temperature below 25 degrees Celsius.

10. The method of claim 9, wherein the first high pressure water stream has a temperature below 20 degrees Celsius.

11. The method of claim 4, wherein the initial high pressure water stream and first ozonated water stream are separated from one another and wherein the first high pressure water stream and second ozonated water stream are separated from one another, the method further comprising conveying the article to the initial high pressure water stream, the first ozonated water stream, the first high pressure water stream, and the second ozonated water stream.

12. The method of claim 4, wherein the initial and first high pressure water streams are sequentially emitted from a common nozzle and wherein the first and second ozonated water streams are sequentially emitted from a common nozzle.

13. A method for cleaning a soiled article, comprising:
first, directing a first high pressure water stream at the article with no application of any saponifying substance, detergent, sanitizer, or cleaning chemical immediately prior to or during directing the first high pressure water stream at the article;
second, directing a first ozonated water stream of at the article;
third, directing a second high pressure water stream at the article; and
fourth, directing a second ozonated water stream at the article;
wherein the first and second high pressure water streams and first and second ozonated water streams contain no detergents.

14. The method of claim 13, wherein the article is a tub soiled with poultry fats.

15. The method of claim 14, further comprising reusing the tub to hold poultry subsequent to directing the second low pressure ozonated water stream at the tub with no intervening application of a saponifying substance, detergent, sanitizer, or cleaning chemical.

16. The method of claim 13, wherein the article is an animal hide.

17. The method of claim 13, wherein the first and second high pressure water streams have a temperature below 25 degrees Celsius.

18. The method of claim 17, wherein the first and second high pressure water streams have a temperature below 20 degrees Celsius.

19. The method of claim 13, wherein the first high pressure water stream and first ozonated water stream are distanced from one another and wherein the second high pressure water stream and second ozonated water stream are distanced from one another and the first ozonated water stream, the method further comprising conveying the article to the first high pressure water stream, the first ozonated water stream, the second high pressure water stream, and the second ozonated water stream.

20. The method of claim 13, wherein the first and second high pressure water streams are sequentially emitted from a common high pressure nozzle and wherein the first and second ozonated water streams are sequentially emitted from a common ozonated water nozzle.
